(19) United States
(12) Patent Application Publication
(10) Pub. No.: US 2025/0314491 A1
(43) Pub. Date: Oct. 9, 2025

(54) COMBINATION TOOL

(71) Applicant: HANGZHOU GREAT STAR INDUSTRIAL CO., LTD., Hangzhou City, Zhejiang Province (CN)

(72) Inventor: Yueming LI, Hangzhou City, Zhejiang Province (CN)

(21) Appl. No.: 18/716,738

(22) PCT Filed: Apr. 8, 2024
(86) PCT No.: PCT/CN2024/086546

§ 371 Date: Jun. 5, 2024

(30) Foreign Application Priority Data
Apr. 3, 2024 (CN) 202410405175.4

(51) Int. Cl. G01C 9/06; G01C 9/34

(52) U.S. Cl. CPC G01C 9/06; G01C 9/34; G01C 2009/066

(57) ABSTRACT

The present invention discloses a combination tool including a housing defining an internal cavity, in which a laser module and a level assembly are provided. The laser module is configured to produce spot-shaped laser light and/or linear laser light. The level assembly is configured to indicate a degree of levelness. The combination tool may further include a rangefinding module and a detection module, which provide the functions of rangefinding, detecting a wood/metal component, or the like.

### FIELD OF THE INVENTION

The present invention relates to the field of measuring tools and, in particular, to a combination tool.

### DESCRIPTION OF THE PRIOR ART

Projection of laser spots and lines is a technique commonly used in construction, interior decoration and other fields. During use of conventional laser spot and line projectors, inaccurate projection may occur if their horizontality or preset angle remains unknown. Therefore, the horizontality, verticality or preset angle of such projectors must be accurately determined before they are used.

Conventional laser spot and line projectors lack multi-functionality, in contrast to the fact that most construction, interior decoration and similar applications require the use of versatile tools.

Therefore, those skilled in the art are directing their effort toward developing combination tools, which can project laser spots and lines, allow accurately determining their own location and provide multiple functions including rangefinding and detection.

### SUMMARY OF THE INVENTION

To this end, the present invention provides a combination tool comprising a housing defining an internal cavity, in which a laser module and a level assembly are provided, the laser module configured to produce spot-shaped laser light and/or linear laser light, the level assembly configured to indicate a degree of levelness.

Additionally, the laser module may comprise at least one laser assembly and may be configured to be switchable between producing the spot-shaped laser light and producing the linear laser light.

Additionally, the laser module may comprise a laser assembly and a switching assembly, the switching assembly configured to be able to control the laser assembly to be switched between producing the spot-shaped laser light and producing the linear laser light.

Additionally, the switching assembly may comprise a slider slideable relative to the housing and a push button capable of driving the slider to slide, the push button connected to the slider, the slider provided with a through hole and a beam splitter, the slider configured so that laser light emitted from the laser assembly passes through the through hole when the slider is at a first position and that laser light emitted from the laser assembly passes through the beam splitter when the slider is at a second position.

Additionally, the laser module may comprise a first laser assembly and a second laser assembly, the first laser assembly configured to emit the spot-shaped laser light, the second laser assembly configured to emit the linear laser light.

Additionally, the laser module may comprise at least two laser assemblies configured to be able to produce laser lines which are perpendicular to each other.

Additionally, the level assembly may comprise at least one bubble configured to indicate a degree of verticality, a degree of perpendicularity or an angle.

Additionally, the at least one bubble may comprise a first bubble and a second bubble, wherein the first bubble is configured to indicate the degree of verticality or the degree of perpendicularity, and the second bubble is a rotatable bubble for indicating the angle, or
wherein the first bubble and the second bubble are arranged perpendicularly to each other.

Additionally, the level assembly may further comprise a corner defined in a side wall of the housing, the corner having a first side and a second side, which are perpendicular to each other.

Additionally, the level assembly may further comprise an angle indicating component configured to indicate an angle at which the combination tool is located, the angle indicating component selected from a protractor or an electronic inclinometer.

Additionally, the housing may be made of a metal material.

Additionally, the housing may be integrally formed of the metal material and provided with a plurality of openings for mounting of the laser module and the level assembly.

Additionally, a side of the housing may define a V-shaped groove extending in a lengthwise direction of the side.

Additionally, the housing may be made of a plastic material and may comprise at least two shells which are put together to define the cavity.

Additionally, the housing may be provided therein with at least one magnetic element for attractively attaching the combination tool to an object to be measured.

Additionally, the housing may be provided therein with at least one rangefinding module comprising a tape measure and/or an ultrasonic rangefinding component.

Additionally, the housing may be provided therein with a detection module configured to detecting a center of a wood component and/or a center of a metal component.

Additionally, the combination tool may further comprise a mounting plate configured to be affixable to a vertical surface, wherein the housing is attached to the mounting plate by an attachment member.

Additionally, the housing may be provided with a micro switch configured to, when the housing is attached to the mounting plate, be triggered to cause the laser module to be turned on.

Additionally, the mounting plate may define a tether hole and/or a lug, the lug defining a through hole for insertion of a fastener therethrough.

The present application offers the benefits as follows:

The combination tool is switchable between laser spot projection and line projection function and can be accurately located itself, allowing improved spot and line projection accuracy. The combination tool has diverse functions by incorporating modules capable of rangefinding, detecting a wood or metal component, etc. The combination tool can be used in more applications, because it can be fixed to a pipe and mounted on a wall.

Below, the concept, structural details and resulting effects of the present application will be further described with reference to the accompanying drawings to provide a full understanding of the objects, features and effects of the application

### BRIEF DESCRIPTION OF THE DRAWINGS

FIG. 1 is a schematic structural view of a multi-functional measuring apparatus according to a first embodiment.

FIG. 2 is a schematic view of FIG. 1, taken from another angle.

FIG. 3 is an exploded partial view of FIG. 1, showing structures within a housing.

FIG. 4 is an enlarged, exploded, partial view of FIG. 1, showing a switching assembly.

FIG. 5 is an exploded partial view of FIG. 1.

FIG. 6 is a schematic diagram of the internal structure of FIG. 1, showing a tape measure structure.

FIG. 7 is a schematic structural view of a multi-functional measuring apparatus according to a second embodiment.

FIG. 8 is a schematic structural view of a housing according to the second embodiment.

FIG. 9 is a schematic exploded view of FIG. 7.

FIG. 10 is a schematic structural view of a multi-functional measuring apparatus according to a third embodiment.

FIG. 11 is a schematic exploded partial view of FIG. 10, showing structures within a housing.

FIG. 12 is a schematic exploded view of FIG. 10, taken from another angle.

FIG. 13 is a schematic exploded view of FIG. 10.

10 FIG. 14 is a schematic bottom view of FIG. 10.

FIG. 15 is a schematic structural view of a multi-functional measuring apparatus according to a fourth embodiment.

FIG. 16 is a front view of FIG. 15.

FIG. 17 is a schematic exploded partial view of FIG. 15.

FIG. 18 is a schematic view of FIG. 17, taken from another angle.

FIG. 19 is a schematic exploded view FIG. 15.

FIG. 20 is a schematic structural view of a multi-functional measuring apparatus according to a fifth embodiment.

FIG. 21 is a schematic view of FIG. 20, taken from another angle.

FIG. 22 is a schematic exploded view of FIG. 20.

FIG. 23 is a schematic view of FIG. 22, taken from another angle.

FIG. 24 is a schematic bottom view of FIG. 20.

FIG. 25 is a schematic structural view of a multi-functional measuring apparatus according to a sixth embodiment.

FIG. 26 is a schematic view of FIG. 25, taken from another angle.

FIG. 27 is a schematic exploded view of FIG. 25.

FIG. 28 is a schematic diagram of the internal structure of FIG. 25, showing a laser module.

FIG. 29 is a schematic illustration of an icon displayed on a display device in the sixth embodiment.

FIG. 30 is a schematic structural view of a multi-functional measuring apparatus according to a seventh embodiment.

FIG. 31 is a schematic view of FIG. 30, taken from another angle.

FIG. 32 is a schematic exploded view of FIG. 30.

FIG. 33 is a schematic illustration of icons displayed on a display device in the seventh embodiment.

FIG. 34 is a schematic structural view of a multi-functional measuring apparatus according to an eighth embodiment.

FIG. 35 is a schematic back view of FIG. 34.

FIG. 36 is a schematic end view of FIG. 34.

FIG. 37 is a schematic view of FIG. 34, taken from another angle.

FIG. 38 is a schematic exploded view of FIG. 34.

### DETAILED DESCRIPTION OF THE PREFERRED EMBODIMENTS

A few preferred embodiments of the present invention will be described more fully hereinafter with reference to the accompanying drawings so that techniques thereof will become more apparent and more readily understood. The invention can be embodied in various different forms and its scope is in no way limited to the embodiments disclosed herein.

Throughout the figures, structurally identical components are indicated with the same reference numerals, and structurally or functionally similar components are indicated with like reference numerals. The dimensions and thickness of each component in the accompanying drawings are arbitrarily shown, and the present invention is not limited to any particular dimension or thickness of any component. In the figures, where appropriate, the thickness of certain components may be somewhat exaggerated for clarity.

### Example 1

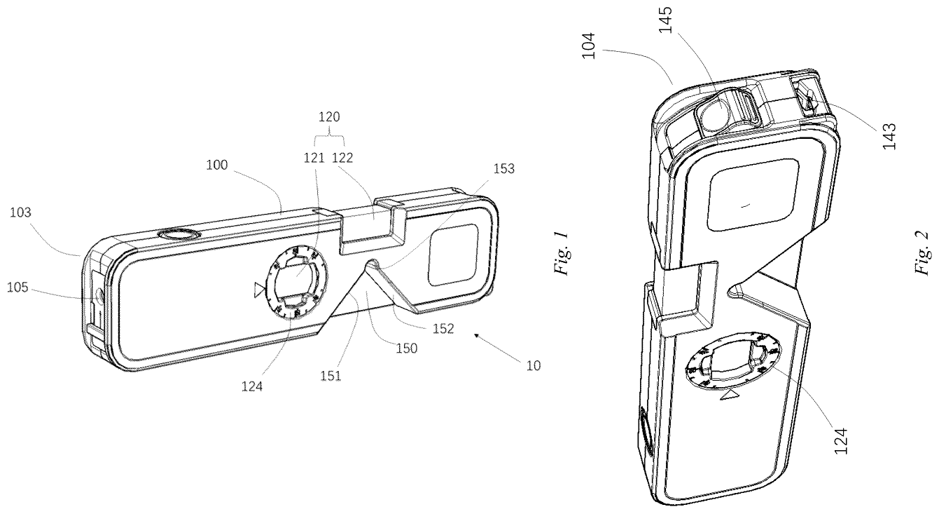

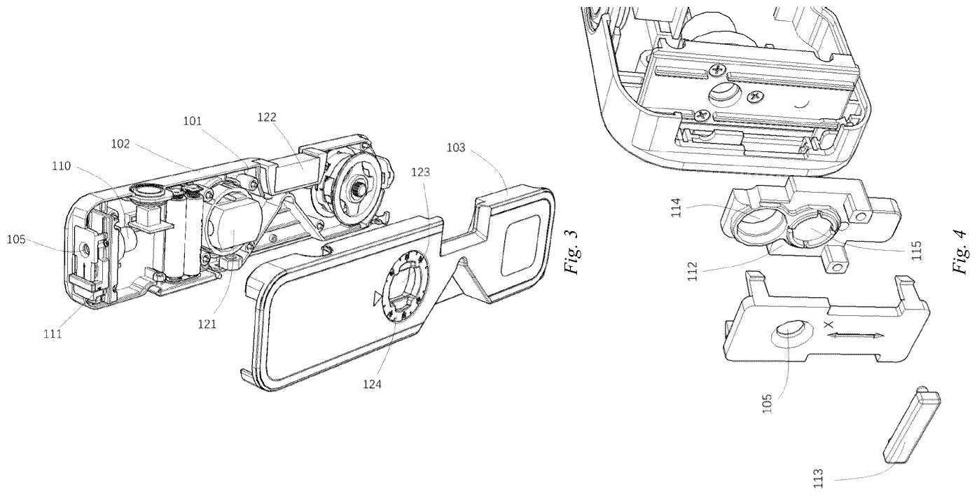

As shown in FIGS. 1 to 6, in a first embodiment of the present invention, there is provided a multi-functional measuring apparatus 10 including a housing 100 defining an internal cavity 101, in which a laser module 110 and a level assembly 120 are provided.

The housing 100 may be fabricated from a plastic or metal material, with a plastic material being preferred. In some implementations, the housing 100 includes a first shell 102 and a second shell 103, which are arranged in opposition to each other and joined together with fasteners so as to together define the cavity 101.

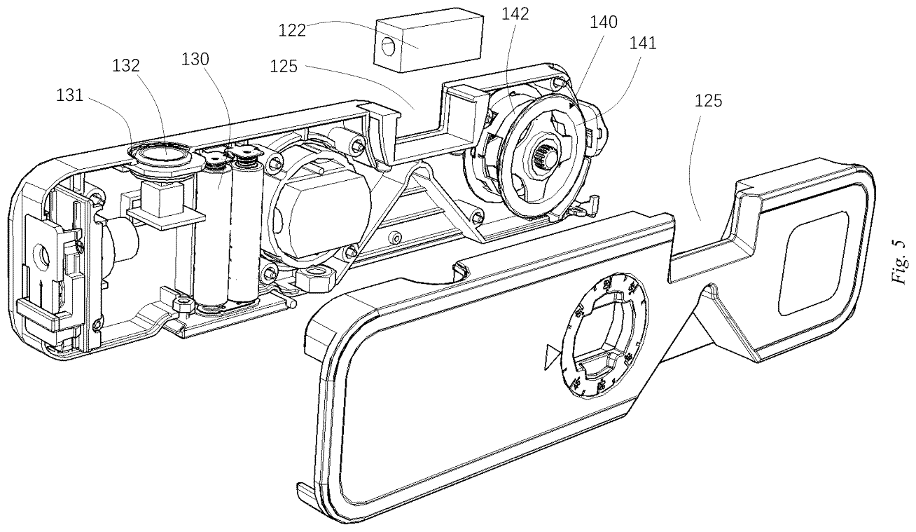

The housing 100 has a first end 103 and a second end 104 opposing the first end 103. The laser module 110 is disposed at the first end 103 of the housing 100, and a tape measure module 140 is disposed at the second end 104 of the housing 100. The housing 100 defines a light exit port 105 at the first end 103. The laser module 110 may emit laser light, which exits through the light exit port 105. In some implementations, laser light emitted from the laser module 110 passes through the light exit port 105 and forms a laser spot. In this way, a spot projection function is provided. In some implementations, laser light emitted from the laser module 110 passes through the light exit port 105 and forms a laser line. In this way, a line projection function is provided. In some implementations, the laser module 110 may switch between the laser spot projection and laser line projection functions. Preferably, the multi-functional measuring apparatus 10 includes a switching assembly 111, which may be controlled so that laser light emitted from the laser module 110 that has passed through the light exit port 105 of the housing 100 switches between forming a laser spot and forming a laser line. In some implementations, as shown in FIG. 4, the switching assembly 111 includes a slider 112 and a push button 113. The slider 112 is disposed between the laser module 110 and the light exit port 105 of the housing 100 so as to be slideable relative to the housing 100. A through hole 114 and a beam splitter 115 are provided on the slider 112 side by side along the direction X of sliding. When the slider 112 is moved to a first position, the beam splitter 115 is located between the light exit port 105 and the laser module 110. As a result, laser light emitted from the laser module 110 successively passes through the beam splitter 115 and the light exit port 105 and forms a laser line. When the slider 112 is moved to a second position, the beam through hole is located between the light exit port 105 and the laser module 110. As a result, laser light emitted from the laser module 110 successively passes through the through hole and the light exit port 105 and forms a laser spot. The push button 113 is coupled to the slider 112 and protrudes out of the housing 100. An external force may be exerted on the push button 113 to drive the slider 112 to slide on the housing 100. Preferably, the direction X of sliding of the slider 112 is the same as a heightwise direction of the housing 100. It should be understood that, instead of the illustrated mechanical mechanism, the switching of the laser module 110 between spot projection and line projection may also be implemented by an appropriately configured hardware circuit, or under the control of a software program.

In some implementations, the multi-functional measuring apparatus 10 may be powered by an external power supply. In some implementations, the multi-functional measuring apparatus 10 may include a power supply module 130, which is disposed in the housing 100, as shown in FIG. 5. The power supply module 130 may include a dry cell battery, a rechargeable battery, or the like, which serves as a power supply. A power supply switch 132 is disposed in a through hole 131 formed in a side wall of the housing 100. The level assembly 120 includes a first bubble 121 disposed within the housing 100. An observation window 123 is arranged in a side wall of the housing 100 at a location aligned with the first bubble 121. The first bubble 121 can be observed through the observation window 123. The first bubble 121 may be a horizontal bubble used to measure levelness in a leveling operation. Alternatively, the first bubble 121 may be an angle level, which can be rotated and used to measure an angle. Preferably, the first bubble 121 is an angle level, and the observation window 123 is shaped like a ring. An annular protractor 124 is provided at the observation window 123. Leveling can be achieved at different angles by rotating the first bubble 121 in combination with use of the protractor 124.

In some implementations, the level assembly 120 further includes a second bubble 122. The second bubble 122 may be provided in the housing 100, and an observation port may be arranged in the housing 100 at a location aligned with the second bubble 122. This may be arranged in the same manner as the first bubble 121. In alternative implementations, as shown in FIG. 5, a recess 125 is provided in one side of the housing 100. The recess 125 is recessed from a side wall of the housing 100, and the second bubble 122 may be mounted in the recess 125. Preferably, the recess 125 is provided in a side wall extending in a lengthwise direction of the housing 100.

In some implementations, in order for the first bubble 121 and/or the second bubble 122 to be more clearly observed, light source(s) may be provided around the bubble(s). After the light source(s) is/are turned on, the bubble(s) can be observed even in a dark area. Preferably, the light source(s) may be implemented as LED lamp(s).

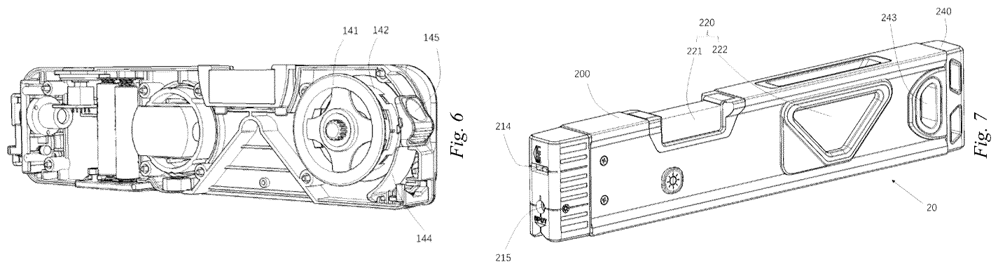

In some implementations, the multi-functional measuring apparatus 10 further includes a tape measure module 140 disposed within the housing 100. The tape measure module 140 may be implemented as a conventional tape measure structure known in the art. For example, referring to FIG. 6, the tape measure module 140 includes a tape reel 141, a measuring tape 142, a tape exit port 143, a lock block 144 and a lock button 145. The tape reel 141 is disposed in the housing 100, and the measuring tape 142 is entirely or partially wound on the tape reel 141. One end of the measuring tape 142 is secured to the tape reel 141. The tape exit port 143 is provided in a side wall of the housing 100, preferably at an end of the side wall. The other end of the measuring tape 142 extends outside of the housing 100 through the tape exit port 143. The lock block 144 is disposed within the housing 100 at a location close to the tape exit port 143. When the measuring tape 142 is pulled out of the housing 100, the lock block 144 can be used to press and lock the measuring tape 142 so that a length of the measuring tape 142 within the housing 100 is maintained unchanged. The lock button 145 is disposed on an external surface of the housing 100 and used to control the lock block 144 to lock or release the measuring tape 142. It should be understood that the tape measure module 140 is not limited to being structured as described herein. According to this embodiment, the tape measure module 140 may be structured otherwise.

In some implementations, the housing 100 defines a right-angled corner 150 on its one side. Specifically, the corner 150 has a first side 151 and a second side 152 inclined at angle of 90° relative to the first side 151. During use, the first side 151 and the second side 152 of the corner 150 may be brough into contact to two sides of an object to be positioned, which are inclined at 90° relative to each other. This, coupled with the leveling capacities of the laser module 110 and/or the bubbles, enables quick level hanging of the object, or checking whether the object is levelly positioned. For example, the corner 150 may be fitted onto two sides of an object that has been positioned, which are inclined at a right angle relative to each other, and the laser module 110 and/or bubbles may be then checked to see if it is levelly positioned. Preferably, the corner 150 has a rounded vertex 153. That is, the joint 153 of the first side 151 and the second side is rounded. This can prevent the vertex of the corner 150 from undesirably interfering with an object.

The multi-functional measuring apparatus 10 of this embodiment can project a laser spot or line, which can facilitate leveling and alignment. Rapid, accurate leveling can be achieved with the aid of the first bubble 121 and the second bubble 122. With the right-angled corner 150, level hanging of a rectangular object can be achieved. The tape measure module 140 can be used to measure a distance.

### Example 2

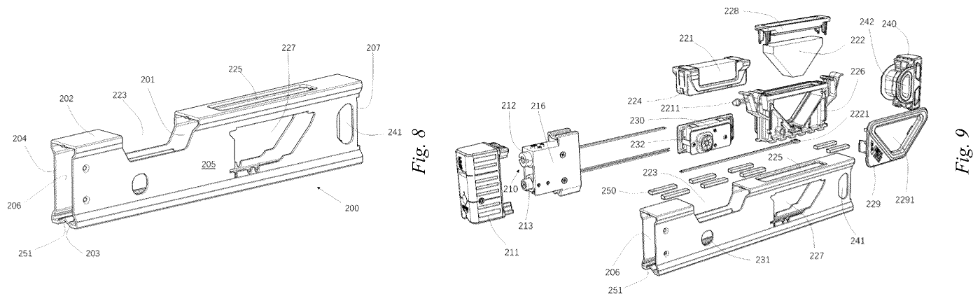

As shown in FIGS. 7 to 9, in a second embodiment of the present invention, there is provided a multi-functional measuring apparatus 20 including a housing 200 defining an internal cavity 201, in which a laser module 210 and a level assembly 220 are provided.

The housing 200 is fabricated from a metal material. Preferably, the housing 200 is an integral structure formed by cutting or stamping a metal sheet. The housing 200 has a first side wall 202 and a second side wall 203, both extending in a heightwise direction. It also has a third side wall 204 and a fourth side wall 205, both extending in a widthwise direction. It further has a first opening 206 and a second opening 207, opposing each other in a lengthwise direction. Preferably, the metal material is an aluminum alloy. The housing 200 may define multiple mounting locations, where the laser module 210 and the level assembly 220 are mounted.

The laser module 210 is mounted at the first opening 206 by means of a first support 216. Preferably, the laser module 210 is mounted on the first support 216, and the first support 216 is then secured to side walls around the first opening 206 (more precisely, to portions respectively of the third side wall 204 and the fourth side wall 205). A first end cover 211 is also provided at the first opening 206. The first end cover 211 may close the first opening 206 and hence covers the laser module 210. A light exit port is provided in the first end cover 211, and laser light emitted from the laser module 210 exits through the light exit port. In some implementations, the laser module 210 includes a laser-line component 212 and a laser-spot component 213. The laser-line component 212 provides a laser line projection function by emitting laser light which forms a line. The laser-spot component 213 provides a laser spot projection function by emitting laser light which forms a spot. To this end, the first end cover 211 defines two light exit ports: a linear light exit port 214 and a point-shaped light exit port 215. The linear light exit port 214 is aligned with the laser-line component 212, and the point-shaped light exit port 215 is aligned with the laser-spot component 213. Compared with the first embodiment, the laser assemblies accomplish laser spot and line projection in a different manner.

In some implementations of this embodiment, the multi-functional measuring apparatus 20 may be powered by an external power supply. In some implementations of this embodiment, the multi-functional measuring apparatus 20 may include a power supply module 230, which is disposed in the housing 200, as shown. The power supply module 230 may include a dry cell battery, a rechargeable battery, or the like, which serves as a power supply. A switch port 231 is provided in a side wall (e.g., the fourth side wall 205) of the housing 200, and a switch is provided at the switch port 231. Specifically, both the power supply module 230 and the switch are connected to a PCB. The laser module 210 may be controlled to emit laser light, through pressing the switch 232. In some implementations, only one switch 232 may be provided, and the laser-spot and laser-line components may be separately controlled by pressing the switch different numbers of times. In some implementations, multiple switches may be provided to separately control the laser-spot and laser-line components.

The level assembly 220 includes a first bubble 221 and a second bubble 222, which are mounted on the housing 200 by means of respective supports. In some implementations, the first bubble 221 is implemented as a rectangular bubble component, and a recess 223 is formed in the housing 200. The rectangular bubble component is mounted on the support 224, and the support 224 is then secured within the recess 223. The second bubble 222 is implemented as a substantially triangular bubble component, and a third opening 225 is formed in the first side wall 202 of the housing 200. The second bubble 222 is mounted on the third support 226, and the third support 226 is then passed through the third opening 225 and secured in the housing 200, so that the second bubble 222 is situated between the third side wall 204 and the fourth side wall 205. In order to facilitate observation of the second bubble 222, fourth openings 227 may be formed respectively in the third side wall 204 and in the fourth side wall 205. In order to additionally secure the second bubble 222, a top cover plate 228 is provided at the third opening 225, which closes the third opening 225. In the top cover plate 228, a through hole substantially matching the second bubble 222 in shape is provided. Moreover, side cover plates 229 are provided at the respective fourth openings 227. The side cover plates 229 are affixed to the housing 200 so as to close the respective fourth openings 227. In the side cover plates 229, respective view windows 2291 substantially matching a lateral shape of the second bubble 222 are provided, through which the second bubble 222 can be observed. The first bubble 221 may be a horizontal bubble used to measure levelness in a leveling operation. The second bubble 222 may be any of a horizontal bubble, a vertical bubble or an angle level. Preferably, the second bubble 222 includes a rotatable bubble.

In some implementations, in order for the first bubble 221 and/or the second bubble 222 to be more clearly observed, light source(s) may be provided around the bubble(s). After the light source(s) is/are turned on, the bubble(s) can be observed even in a dark area. Preferably, the light source(s) may be implemented as LED lamp(s). As shown, a first light source 2211 is provided around the first bubble 221, and a second light source 2221 is provided around the second bubble 222. The first light source 2211 and the second light source 2221 are both connected to the power supply module 230 and may be both controlled by the switch 232.

In some implementations, the second opening 207 is closed with a second end cover 240. Through holes 241 are provided in side walls around the second opening 207 (more precisely, in portions respectively of the third side wall 204 and the fourth side wall 205). A hollow cylinder 242 is passed through the through holes 241 and is joined to an extension of the second end cover 240. The hollow in the cylinder 242 forms a tether hole 243, which can facilitate stowing.

A plurality of magnetic elements 250 may be provided in the second side wall 203. With these magnetic elements 250, the multi-functional measuring apparatus 20 of this embodiment can be attached to a surface being measured. The magnetic elements 250 may be implemented as magnet sheets made of a rare earth magnetic material. In some implementations, the second side wall 203 has an inverted V-shaped cross-section. That is, the second side wall 203 defines a V-shaped groove 251 extending in the lengthwise direction. With the V-shaped groove 251, the multi-functional measuring apparatus 20 of this embodiment can be placed on a pipe being mounted, facilitating measurement of levelness, inclination and verticality of the pipe.

The multi-functional measuring apparatus 20 of this embodiment can project laser light, facilitating leveling and alignment. Moreover, it may incorporate a 180-degree bubble and a rotatable bubble, which allows rapid, convenient leveling. The V-shaped groove 251 enables measurement of a pipe, and the rare earth magnets enable effective alignment. With the light source(s), measurements can be made with the bubbles in dark areas.

### Example 3

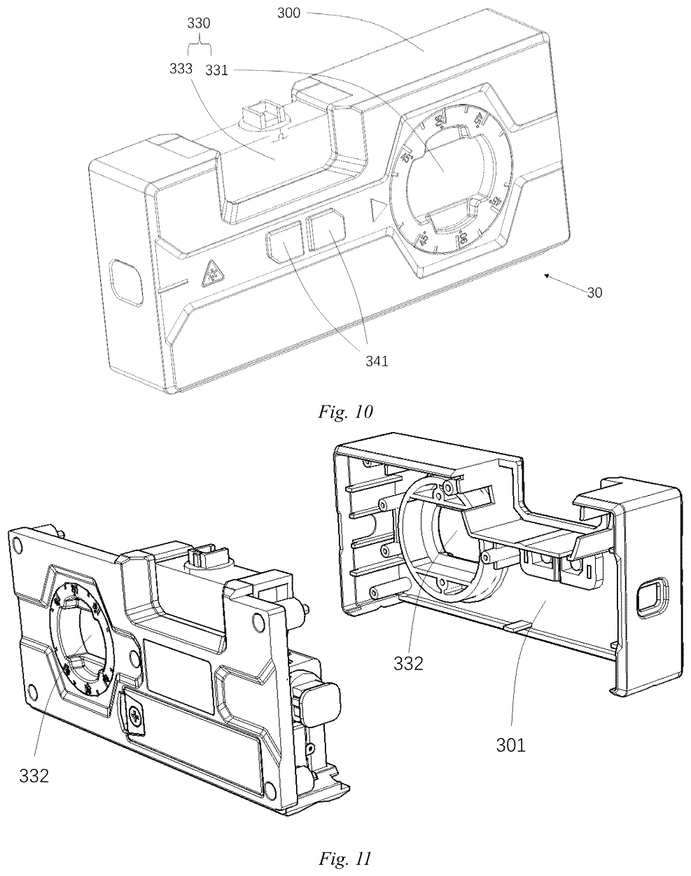

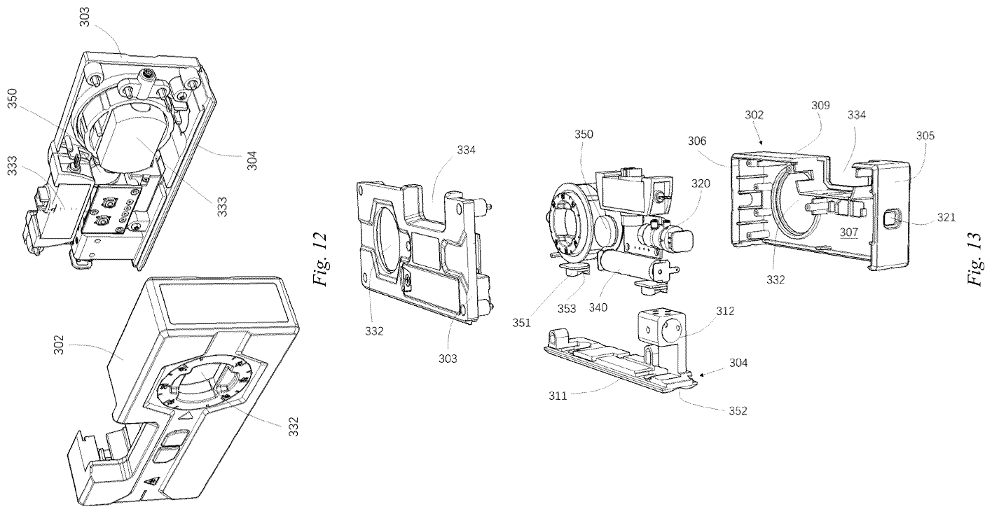

As shown in FIGS. 10 to 14, in a third embodiment of the present invention, there is provided a multi-functional measuring apparatus 30 including a housing 300 defining an internal cavity 301, in which a laser module 310 and a level assembly 320 are provided.

The housing 300 is fabricated from a metal material and includes a first shell 302, a second shell 303 and a third shell 304. Preferably, the first shell 302 and the second shell 303 are formed by cutting or stamping a metal sheet. The first shell 302 has a first side wall 305 and a second side wall 306, opposing each other in a lengthwise direction. Of two sides of the first shell 302 that oppose each other in a widthwise direction, a third side wall 307 is disposed at one side, and a first opening is provided at the other side. The first opening is covered by the second shell 303. Of two sides of the first shell 302 that oppose each other in a heightwise direction, a fourth side wall 309 is disposed at one side, and a second opening is provided at the other side. The second opening is covered by the third shell 304. The third shell 304 includes a base 311 and a mounting support 312 provided on the base 311. The base 311 covers the second opening so that the mounting support 312 is inserted through the second opening into the cavity 301 of the housing 300. The laser module 320 is arranged on the mounting support 312. The housing 300 may define multiple mounting locations, where the laser module 210 and the level assembly 220 are mounted.

The laser module 320 is mounted on the mounting support 312, and a light exit port 321 is defined in a first side wall 305 of the first shell 302. Laser light emitted from the laser module 320 exits through the light exit port 321. Differing from the first and second embodiments, the laser module 320 is switched electronically between spot projection and line projection in this embodiment. That is, in this embodiment, the laser module 320 is switched between spot projection and line projection under the control of software.

The level assembly 330 includes a first bubble 331 disposed within the housing 300. Observation windows 332 both aligned with the first bubble 331, through which the first bubble 331 can be observed, may be arranged respectively on the third side wall 307 of the first shell 302 and the opposing second shell 303. The first bubble 331 may be a horizontal bubble used to measure levelness in a leveling operation. Alternatively, the first bubble 331 may be an angle level, which can be rotated and is used to measure an angle. Preferably, the first bubble 331 is an angle level, and the observation window 332 is shaped like a ring. An annular protractor is provided at the observation window 332. Leveling can be achieved at different angles by rotating the first bubble 331 in combination with use of the protractor.

In some implementations, the level assembly 330 further includes a second bubble 333. The second bubble 333 may be provided in the housing 300, and an observation port may be arranged in the housing 300 at a location aligned with the second bubble 333. This may be arranged in the same manner as the first bubble 331. In alternative implementations, as shown, a recess 334 is provided in the fourth side wall 309 of the first shell 302 and the second shell 303. The recess 334 is recessed from the fourth side wall 309, and the second bubble 333 may be mounted in the recess 334. The second bubble 333 may be implemented as a rectangular bubble component, which can be used to realize leveling.

In some implementations, in order for the first bubble 331 and/or the second bubble 333 to be more clearly observed, light source(s) may be provided around the bubble(s). After the light source(s) is/are turned on, the bubble(s) can be observed even in a dark area. Preferably, the light source(s) may be implemented as LED lamp(s).

In some implementations, the multi-functional measuring apparatus 30 may be powered by an external power supply. In some implementations, the multi-functional measuring apparatus 30 may include a power supply module 340, which is disposed in the housing 200, as shown. The power supply module 340 may include a dry cell battery, a rechargeable battery, or the like, which serves as a power supply. A switch port is provided in a side wall of the housing 300, and a power supply switch 341 is provided at the switch port. Two such power supply switches 341 may be included, one of which is used to control the laser module 320, and the other is used to control the light source(s).

In some implementations, a first magnetic element 350 is provided in the first shell 302. The first magnetic element 350 may be provided on the fourth side wall 309. This allows the multi-functional measuring apparatus 30 to be attached to a vertical wall surface with the aid of an iron plate.

In some implementations, at least one second magnetic element 351 is provided on the third shell 304 in the vicinity of the base 311. Preferably, the base 311 defines, in its external surface, a V-shaped groove 352 (similar to the V-shaped groove 352 of the second embodiment), which facilitates use on a pipe. Alternatively, the second magnetic element 351 may be provided in the base 311 and configured to include a V-shaped portion 353. As shown, the side of the second magnetic element 351 facing the base 311 may be inverted V-shaped and substantially match the V-like shape of the base 311.

Compared with the first and second embodiments, the multi-functional measuring apparatus 30 of this embodiment has a compacter structure and a smaller overall size. The laser assembly is capable of spot and line projection. The first bubble 331 can be used to achieve leveling, and the second bubble 333 can be used to provide a reference angle of inclination. The backside magnetic component enables use on a wall surface. The V-shaped groove 352 and V-shaped magnetic element in the base can facilitate measurements required in leveling, line projection and other operations performed on an iron pipe.

### Example 4

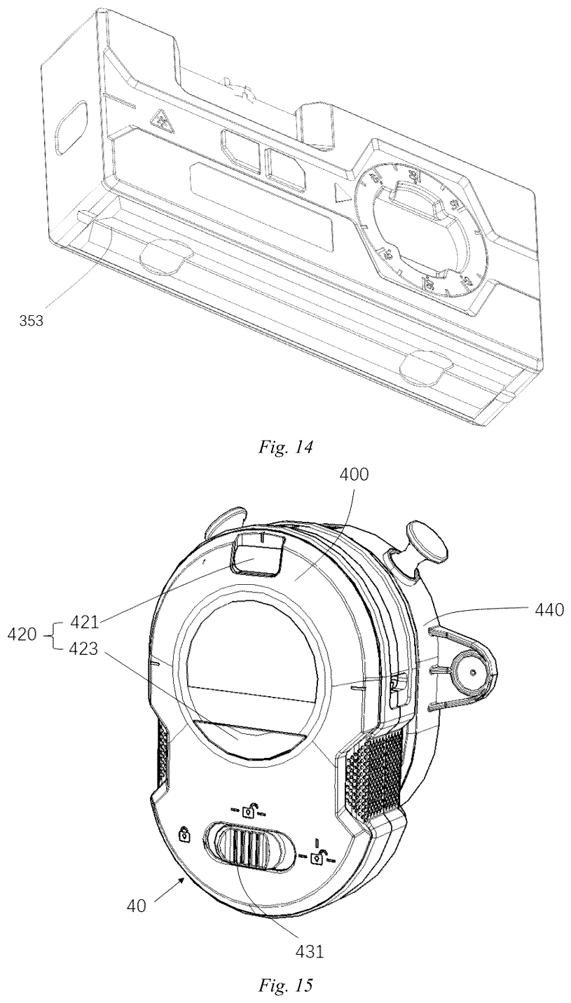

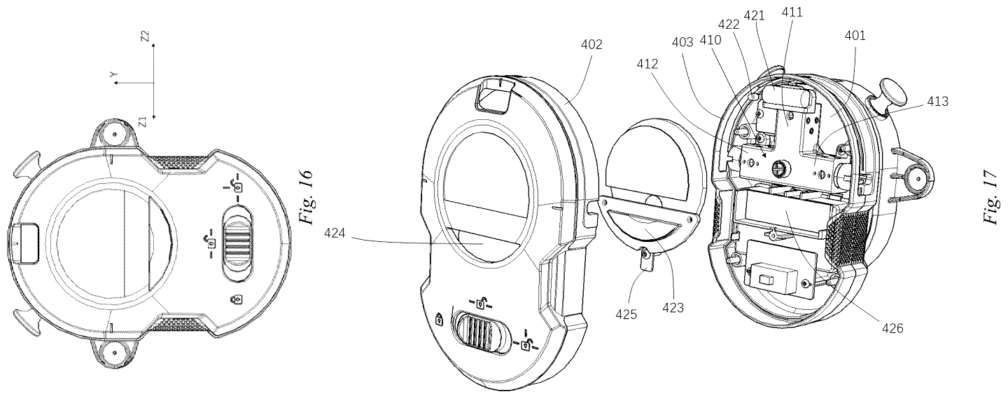

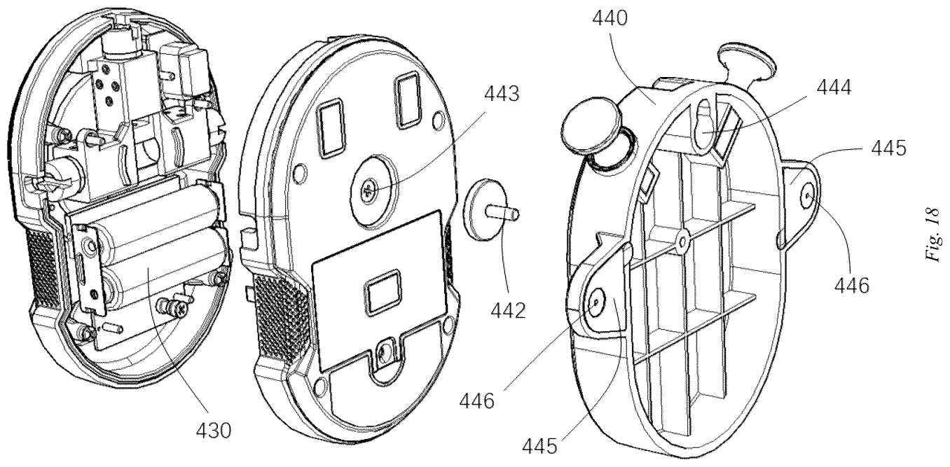

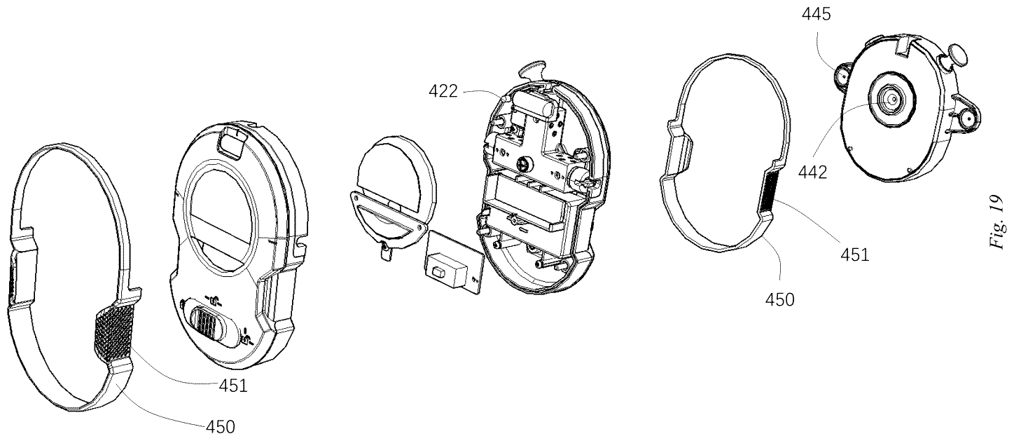

As shown in FIGS. 15 to 19, in a fourth embodiment of the present invention, there is provided a multi-functional measuring apparatus 40 including a housing 400 defining an internal cavity 401, in which a laser module 410 and a level assembly 420 are provided.

The housing 400 may be fabricated from a plastic or metal material, with a plastic material being preferred. In some implementations, the housing 100 includes a first shell 402 and a second shell 403. The first shell 402 is open at one side facing in a thickness direction. The first shell 402 defines an internal cavity 401, and the opening is closed by the second shell 403.

The laser module 410 includes laser assemblies, namely, a first laser assembly 411, a second laser assembly 412 and a third laser assembly 413. The first laser assembly 411 emits laser light in a first direction X. The second laser assembly 412 emits laser light in a second direction Z1. The third laser assembly 413 emits laser light in a third direction Z2. The second direction Z1 is opposite to the third direction Z2, and the first direction Y is perpendicular to both the second direction Z1 and the third direction Z2. For example, in case of the first direction Y being vertical, laser light emitted from the multi-functional measuring apparatus 40 of this embodiment enables alignment in both vertical and horizontal directions. The laser module 410 may be switched between spot projection and line projection in the same manner as described above in the third embodiment, and further description thereof is omitted herein.

The level assembly 420 includes a first bubble 420 disposed at the top of the housing 400 (facing in the first direction). The first bubble 420 may indicate a degree of levelness or verticality. In some implementations, in order for the first bubble 420 to be more clearly observed, a first light source 422 is provided around the bubble. After the light source is turned on, the bubble can be observed even in a dark area. Preferably, the light source may be implemented as an LED lamp.

The level assembly 420 further includes a protractor 423 provided under the first bubble 420. The protractor 423 is disposed within the housing 400 and may be rotatable relative to the housing 400. A view window 424 for the protractor 423 is provided in the second shell 403, and an indicating pointer 425 is provided at the middle of the view window 424. After a rotation of the protractor 423, the indicating pointer 425 indicates an angle measurement. When the multi-functional measuring apparatus 40 is positioned non- horizontally, the protractor 423 will rotate and indicate an angle of inclination of the multi-functional device from a horizontal position. In some implementations, in order for tick marks on the protractor 423 to be more clearly observed, a second light source 426 is provided around the protractor 423. After the second light source 426 is turned on, the tick marks on the protractor 423 can be observed even in a dark area. Preferably, the second light source 426 may be implemented as an LED lamp, preferably as an LED strip.

In some implementations of this embodiment, the multi-functional measuring apparatus 40 may be powered by an external power supply. In some implementations of this embodiment, the multi-functional measuring apparatus 40 may include a power supply module 430, which is disposed in the housing 400, as shown. The power supply module 430 may include a dry cell battery, a rechargeable battery, or the like, which serves as a power supply. A switch port is provided in the second shell 403, and a switch 431 is provided at the switch port. The laser module 410 and the light sources may be turned on and off under the control of the switch 431.

In some implementations, the multi-functional measuring apparatus 40 of this embodiment further includes a mounting plate 440. The mounting plate 440 may be attached to a vertical surface being measured, and the housing 400 of the multi-functional measuring apparatus 40 may be then in turn attached to the mounting plate 440. As such, the multi-functional measuring apparatus 40 may be used on a vertical surface being measured to perform functions like vertical and perpendicular laser line and spot projection and levelness and verticality measurement. An attachment post 441 is provided at the side of the housing 400 facing the mounting plate 440, and the mounting plate 440 defines an attachment socket 442 for receiving the attachment post 441. The attachment of the housing 400 to the mounting plate 440 can be accomplished by inserting the attachment post 441 into the attachment socket 442, and the attachment of the mounting plate 440 to a vertical surface being measured enables wall-mounted use of the multi-functional measuring apparatus 40 for measurement. In some implementations, a micro switch 443 is provided at the attachment post 441 and connected to the laser module 410. Once the attachment post 441 is inserted into the mounting plate 440, the micro switch 443 is triggered, allowing operation of the laser module 410.

The mounting plate 440 may be attached to a vertical surface being measured in many ways. In some implementations, the mounting plate 440 defines at its top a tether hole 444, with which the mounting plate 440 may be hung on a vertical surface. In some implementations, glue is applied to a backside of the mounting plate 440 (the side facing a vertical surface), with which the mounting plate 440 can be firmly bonded to the vertical surface. In some implementations, the mounting plate 440 defines two lugs 445 on respective opposing sides thereof, and each of the lugs 445 defines a through hole 446 therein. Fasteners are then passed through the through holes 446 and inserted into a vertical surface, thereby affixing the mounting plate 440. It should be understood that the mounting plate 440 is not limited to being attached in any of the above three ways, and any other suitable method can be used to accomplish the attachment of the mounting plate 440. It should be also understood that, depending on the material of the vertical surface, either a single attachment method, or multiple attachment methods in combination, may be used.

In some implementations, a protective cover 450 is further provided on an external surface of the housing 400. As shown, the protective cover 450 may cover at least part of the exterior of the housing 400. An external surface of the protective cover 450 defines a grip with concavities and convexities, which can help to prevent slippage and facilitate gripping during use. Preferably, the protective cover 450 is provided on a circumferential side surface of the housing 400, without covering light exit ports through which laser light is emitted from the laser assemblies.

With the mounting plate 440, wall-mounted use of the multi-functional measuring apparatus 40 of this embodiment is made possible. After the mounting plate 440 is affixed to a vertical surface, the housing 400 may be attached to the mounting plate 440.

While the housing 400 is being rotated, the protractor 423 may be used to monitor an angle of inclination of the multi-functional measuring apparatus 40. Once the multi- functional measuring apparatus is moved to a vertical position as a result of rotating the housing 400, the laser assemblies may emit respective three laser beams, providing line or spot projection functions in both the vertical and horizontal directions.

### Example 5

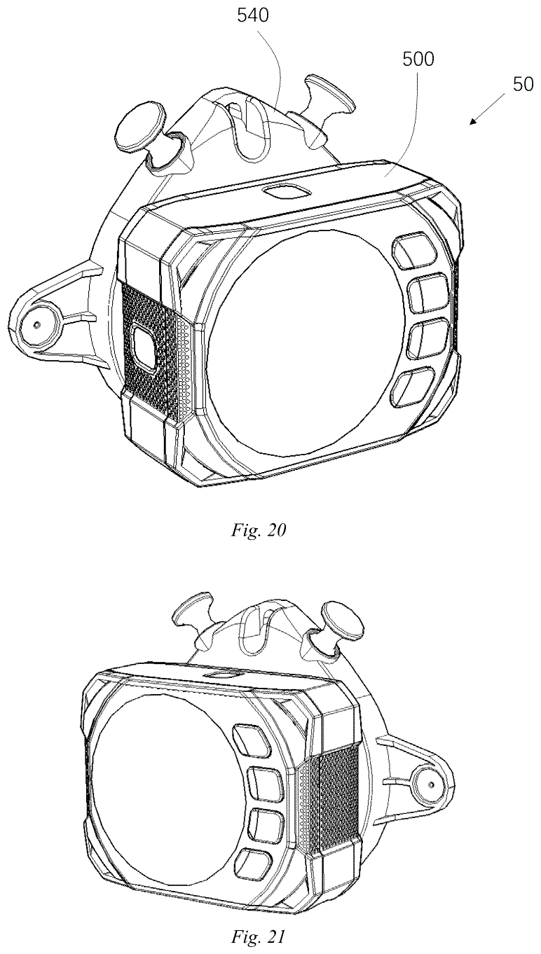

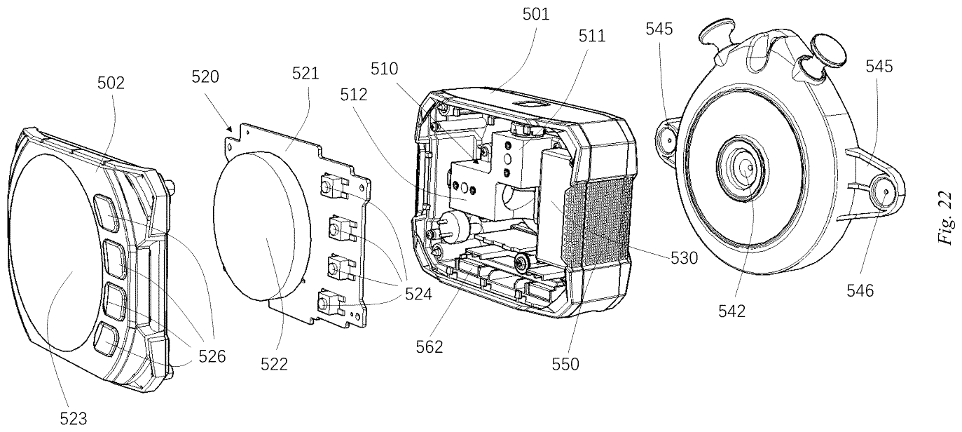

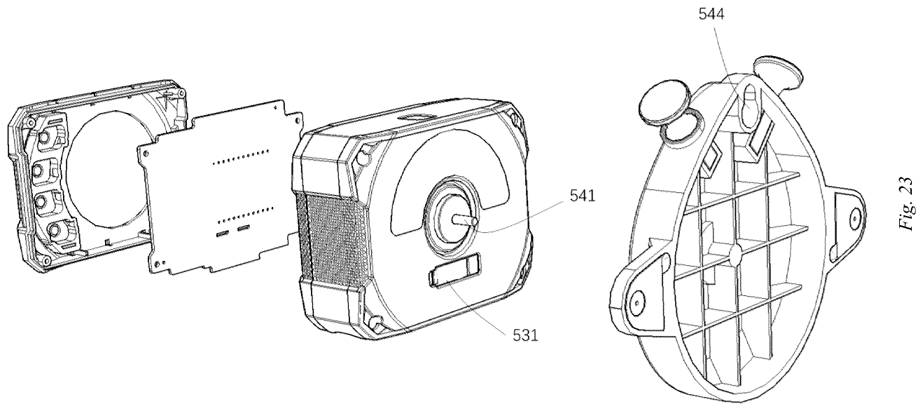

As shown in FIGS. 20 to 24, in a fifth embodiment of the present invention, there is provided a multi-functional measuring apparatus 50 including a housing 500 defining an internal cavity, in which a laser module 510 and a level assembly are provided.

The housing 500 may be fabricated from a plastic or metal material, with a plastic material being preferred. In some implementations, the housing 500 includes a first shell 501 and a second shell 502. The first shell 501 is open at one side facing in a thickness direction. The first shell 501 defines an internal cavity, and the opening is closed by the second shell 502.

In this embodiment, the laser module 510 includes two laser assemblies, namely, a first laser assembly 511 and a second laser assembly 512. The first laser assembly 511 emits laser light in a first direction, and the second laser assembly 512 emits laser light in a second direction perpendicular to the first direction. For example, in case of the first direction being vertical, patterns that laser light emitted from the multi-functional measuring apparatus 50 of this embodiment can form includes, horizontal lines, vertical lines and crosses. The laser module 510 may be switched between spot projection and line projection in the same manner as described above in the third embodiment, and further description thereof is omitted herein. It should be understood that the laser module 410 of the fourth embodiment (with three laser assemblies) is also applicable to this embodiment.

The level assembly includes an electronic inclinometer 520 for measuring an angle of inclination and a degree of levelness. As shown, the multi-functional measuring apparatus 50 of this embodiment includes the electronic inclinometer 520, a PCB 521 and a display device 522. The PCB 521 is mounted within the housing 500, and the electronic inclinometer 520 is connected to the PCB 521. The first shell 501 defines an opening 523, where the display device 522 is disposed. The display device 522 is connected to the PCB 521 and can display a measurement of the electronic inclinometer 520. For example, the display device 522 may display, among others, a numerical angle value, or electronic tick marks and an electronic pointer pointing to one of the tick marks corresponding to an angle. That is, it can display an angle either in the form of a numerical value, or in the form of angle tick marks. For example, the display device 522 may display a circular annulus around its periphery. The circular annulus may consist of angle tick marks and vary with a variation in angle, thus indicating an angle value in an intuitive style. Alternatively, it may display a bright dot and indicate an angle by a degree of curvature. The position of the bright dot may vary with a variation in angle, thus indicating an angle value in an intuitive style. In some implementations, examples of a measurement range of the electronic inclinometer 520 may include 0-90°, 0-180°, 0-360°, etc.

In some implementations, a plurality of buttons are provided on the PCB 521, which may be used to turn on and off the multi-functional measuring apparatus 50, control operation and measurement modes of the laser module 510, maintain a current value, or perform other tasks. Preferably, four switches are provided on the PCB 521, and the first shell 501 define button apertures each corresponding to a respective one of the four switches. Each switch is covered by a button hood 526 provided in the respective button aperture. The switches can be manipulated by pressing the respective button hoods 526.

In some implementations of this embodiment, the multi-functional measuring apparatus 50 may be powered by an external power supply. In some implementations of this embodiment, the multi-functional measuring apparatus 50 may include a power supply module 530, which is disposed in the housing 500, as shown. The power supply module 530 may include a dry cell battery, a rechargeable battery, or the like, which serves as a power supply. In this embodiment, it is preferred to be a rechargeable battery. A USB port 531 may be provided on a backside of the first shell 501, which can be used to charge the rechargeable battery.

In some implementations, the multi-functional measuring apparatus 50 of this embodiment further includes a mounting plate 540. The mounting plate 540 may be attached to a surface being measured, and the housing 500 of the multi-functional measuring apparatus 50 may be then in turn attached to the mounting plate 540. As such, the multi-functional measuring apparatus 50 may be used on a vertical surface being measured to perform functions like vertical and perpendicular laser line and spot projection and levelness and verticality measurement. An attachment post 541 is provided at the side of the housing 500 facing the mounting plate 540, and the mounting plate 540 defines an attachment socket 542 for receiving the attachment post 541. The attachment of the housing 500 to the mounting plate 540 can be accomplished by inserting the attachment post 541 into the attachment socket 542, and the attachment of the mounting plate 540 to a vertical surface being measured enables wall-mounted use of the multi-functional measuring apparatus 50 for measurement. In some implementations, a micro switch is provided at the attachment post 541 and connected to the laser module 510. Once the attachment post 541 is inserted into the mounting plate 540, the micro switch is triggered, allowing operation of the laser module 510.

The mounting plate 540 may be attached to a vertical surface being measured in many ways. In some implementations, the mounting plate 540 defines at its top a tether hole 544, with which the mounting plate 540 may be hung on a vertical surface. In some implementations, glue is applied to, or suction cups are provided on, a backside of the mounting plate 540 (the side facing a vertical surface), with which the mounting plate 440 can be firmly bonded to the vertical surface, which may be optionally a smooth surface. In some implementations, the mounting plate 540 defines two lugs 545 on respective opposing sides thereof, and each of the lugs 545 defines a through hole 546 therein. Fasteners are then passed through the through holes 546 and inserted into a vertical surface, thereby affixing the mounting plate 540. It should be understood that the mounting plate 540 is not limited to being attached in any of the above three ways, and any other suitable method can be used to accomplish the attachment of the mounting plate 540. It should be also understood that, depending on the material of a vertical surface, either a single attachment method, or multiple attachment methods in combination, may be used.

In some implementations, a protective cover 550 is further provided on an external surface of the housing 500. As shown, the protective cover 550 may cover at least part of the exterior of the housing 500. An external surface of the protective cover 550 defines a grip with concavities and convexities, which can help to prevent slippage and facilitate gripping during use. Preferably, the protective cover 550 is provided on a circumferential side surface of the housing 500, without covering light exit ports through which laser light is emitted from the laser assemblies.

In some implementations, a sound output element is provided in the housing 500, which outputs information such as system prompts and results.

In some implementations, a first magnetic element is provided on the backside of the first shell 501, which allows the multi-functional measuring apparatus 50 to be attached to a vertical wall surface with the aid of an iron plate.

In some implementations, at least one second magnetic element 562 is provided at the bottom of the first shell 501. Preferably, a bottom surface of the first shell 501 defines a V-shaped groove 563 (similar to the V-shaped groove 563 of the second embodiment), which can facilitate use on a pipe. Additionally, the second magnetic element 562 may be provided in the first shell 501.

Compared with the fourth embodiment, the multi-functional measuring apparatus 50 of this embodiment provides the same functions while replacing the bubbles and the protractor with the electronic inclinometer 520. Moreover, the multi-functional measuring apparatus 50 of this embodiment provides additional functions like wall-mounted use and pipe measurement by means of the magnetic components arranged respectively around the bottom V-shaped groove 563 and on a backside of the housing 500.

### Example 6

In a sixth embodiment, there is provided a multi-functional measuring apparatus 60 with line projection and detection capabilities. It includes a laser module 610 with line projection capabilities and a detection module for detecting edges of an object made of a wood, metal or other material, from which the center of the object can be estimated.

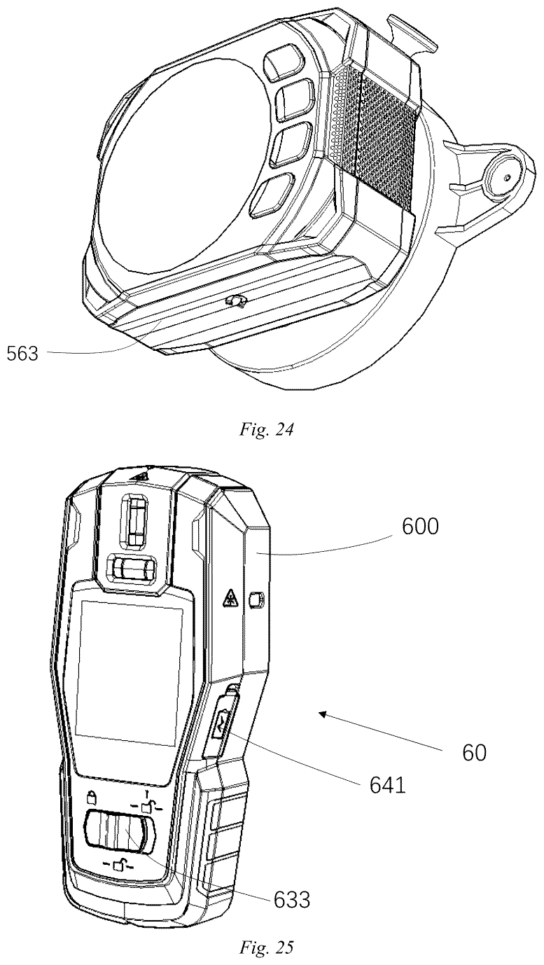

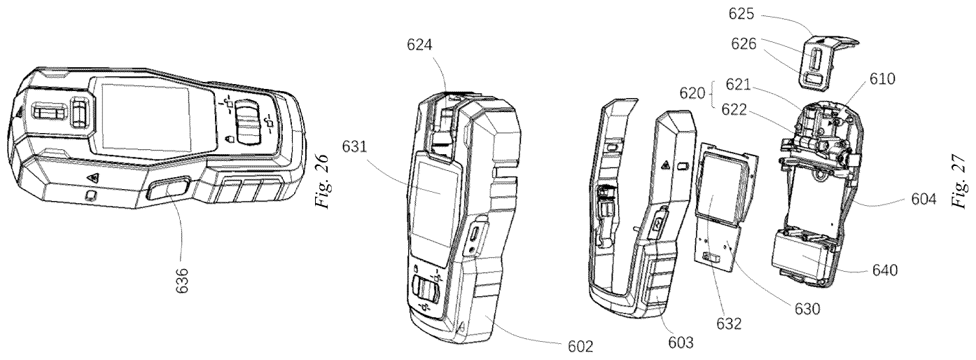

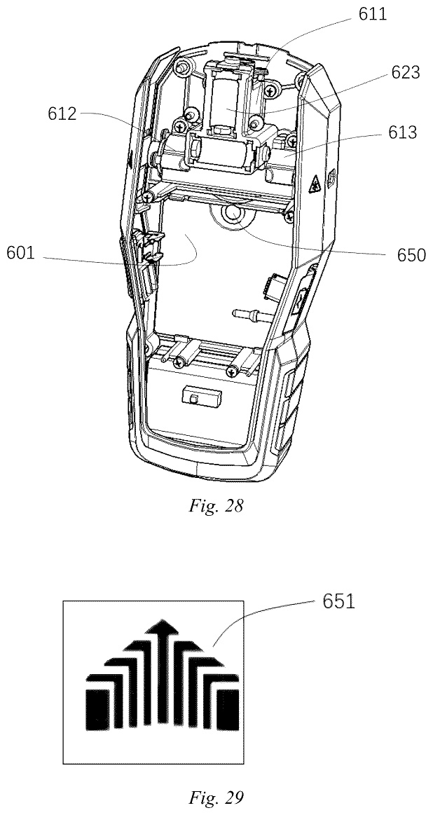

As shown in FIGS. 25 to 29, the multi-functional measuring apparatus 60 of this embodiment includes a housing 600 defining an internal cavity 601, in which the laser module 610, a level assembly 620 and the detection component are provided.

The housing 600 may be fabricated from a plastic or metal material, with a plastic material being preferred. In some implementations, the housing 600 includes a first shell 602, a second shell 603 and a third shell 604. The second shell 603 is open on its both sides opposing in a thickness direction. The third shell 604 closes one of the openings of the second shell 603, and the first shell 602 covers the second shell 603 and closes the other opening of the second shell 603. The three shells are put together to form the housing 600 that defines the internal cavity 601.

The laser module 610 includes three laser assemblies, namely, a first laser assembly 611, a second laser assembly 612 and a third laser assembly 613. The first laser assembly 611 emits laser light in a first direction. The second laser assembly 612 emits laser light in a second direction. The third laser assembly 613 emits laser light in a third direction. The second direction is opposite to the third direction, and the first direction is perpendicular to both the second and third directions. For example, in case of the first direction being vertical, patterns that laser light emitted from the multi-functional measuring apparatus 60 of this embodiment can form includes, horizontal lines, vertical lines and crosses, which enable alignment in both the vertical and horizontal directions.

The level assembly 620 includes a first bubble 621 disposed at the top of the housing 600 (facing in the first direction), which may indicate a degree of levelness or verticality. Preferably, the first bubble 621 is vertically arranged to indicate a degree of verticality.

In some implementations, the level assembly 620 further includes a second bubble 622, which may be horizontally arranged under the first bubble 621. That is, the second bubble 622 and the first bubble 621 may be arranged perpendicularly to each other. The second bubble 622 may be used to indicate a degree of levelness.

The first bubble 621 and the second bubble 622 may be provided on a support 623, and the first shell 602 may define a notch 624 at the top. The support 623 may be mounted in the notch 624, and the notch 624 may be then covered with an end cover 625. The end cover 625 may define view windows 626, which are aligned with the respective bubbles, and through which the respective bubbles can be observed.

A PCB 630 is disposed in the cavity 601 of the housing 600, and a display window 631 is provided at the middle of the first shell 602. A display device 632 is disposed in the display window 631, which can display information such as a state of the measuring apparatus 60 and measurements. The display device 632 is connected to the PCB 630. An opening is provided under the display window 631 in the first shell 602, and a first button 633 is disposed in the opening. The first button 633 is connected to the PCB 630. Another opening is provided in a side of the first shell 602, and a second button 636 is disposed in the opening. The second button 636 is connected to the PCB 630. The first button 633 may be configured with three switching positions: a first position, which is an OFF position; a second position, at which a horizontal laser line may be projected; and a third position, both a horizontal laser line and a vertical laser line may be projected.

In some implementations, the multi-functional measuring apparatus 60 may be powered by an external power supply. In some implementations, the multi-functional measuring apparatus 60 may include a power supply module 640, which is disposed in the housing 600, as shown. The power supply module 640 may include a dry cell battery, a rechargeable battery, or the like, which serves as a power supply. Preferably, a rechargeable battery is included as a power supply. A USB charge port 641, which can be used to charge the rechargeable battery, is provided in a side of the first shell 602.

In some implementations, a first magnetic element 650 is provided on the first shell 602. The first magnetic element 650 may be inserted through the first shell 602 so as to be flush with a backside of the first shell 602. With this arrangement, the multi-functional measuring apparatus 60 can be attached to a vertical wall surface with the aid of an iron plate.

In some implementations of this embodiment, the multi-functional measuring apparatus 60 further includes a mounting plate, which enables the apparatus to be attached to a vertical surface being measured. The mounting plate is structured and attached to a vertical surface in the same manners as described above in the fourth and fifth embodiments.

The detection component may be used to detect edges of a wood post, metal, wire or other object, from which the center of the object can be estimated. The detection component operates by emitting electromagnetic waves which transmit through an object being detected (e.g., a wall), detecting echo signals of the waves and deriving information about the internal structure of the wall from the echo signals. The detection component may be a microwave, infrared or ultrasonic detection component. For example, in case of a microwave detection component, at first, microwave signals are transmitted and propagate into the wall, where when they strike a wood post, metal, wire or another object, reflected signals will be generated. After receiving the reflected microwave signals, the detector analyzes their frequency, amplitude, phase and other parameters, thereby determining what the object is and producing a result which carries the area, volume, center and other information of the object in the wall.

As shown in FIG. 29, the display device 632 may display an icon 651 consisting of a series of bars which decrease in height from the middle to both sides one after another. When the first button 633 is pressed, the multi-functional measuring apparatus 60 can be turned on. After that, it may be placed on a wall being measured, followed by a long press on the second button 636 for initiating a calibration process. In response, the icon 651 brightens up. After the calibration process is completed, the icon 651 dims down. The multi-functional measuring apparatus 60 may be then slowly moved on the wall. For example, when it is moved in a right-to-left direction over a wood or metal post, the icon 651 may brighten up. More specifically, as the apparatus is being moved to the left, the bars may brighten up one after another from the leftmost inwardly, but the middle one remains dim. The apparatus may be then further moved to the left, and when it passes over the center of the wood or metal post, the middle bar may brighten up. At this time, when the multi-functional measuring apparatus 60 is additionally moved to the left away from the center of the wood or metal post, the bars in the icon 651 may dim down one after another from the middle rightwards. When the apparatus is moved over the wood or metal post in a left-to-right direction, the bars in the icon 651 will brighten up or dim down one after another in a reverse order.

In some implementations, a light indicator and an acoustic alarm are further included.

In this embodiment, the detection component may be able to detect a wood or metal post located under it at a depth as large as 19 mm. Moreover, it may be able to detect a charged wire located under it at a depth as large as 35 mm. In this embodiment, three independent horizontal and vertical laser lines with high brightness can be projected, which can be used to achieve leveling and alignment. With the two built-in bubbles, it is ensured that leveling is achieved in a quick and accurate manner. This embodiment can be suitably used to locate wood and metal materials in walls, flooring and ceiling of houses, which are hidden from view.

### Example 7

In a seventh embodiment, there is provided a multi-functional measuring apparatus 70 with line projection and detection capabilities. It includes a laser module 710 with line projection capabilities and a detection module for detecting edges of an object made of a wood, metal or other material, from which the center of the object can be estimated.

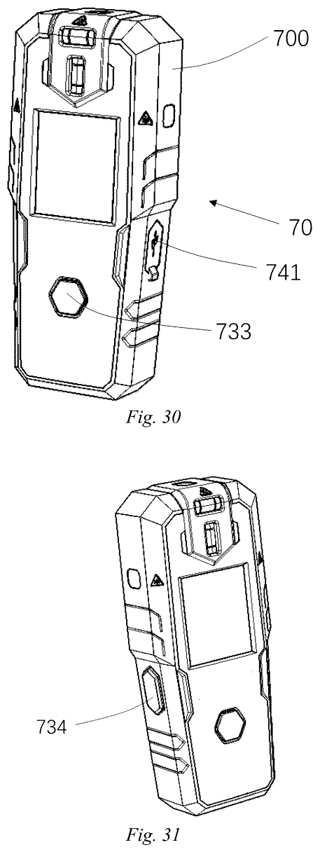

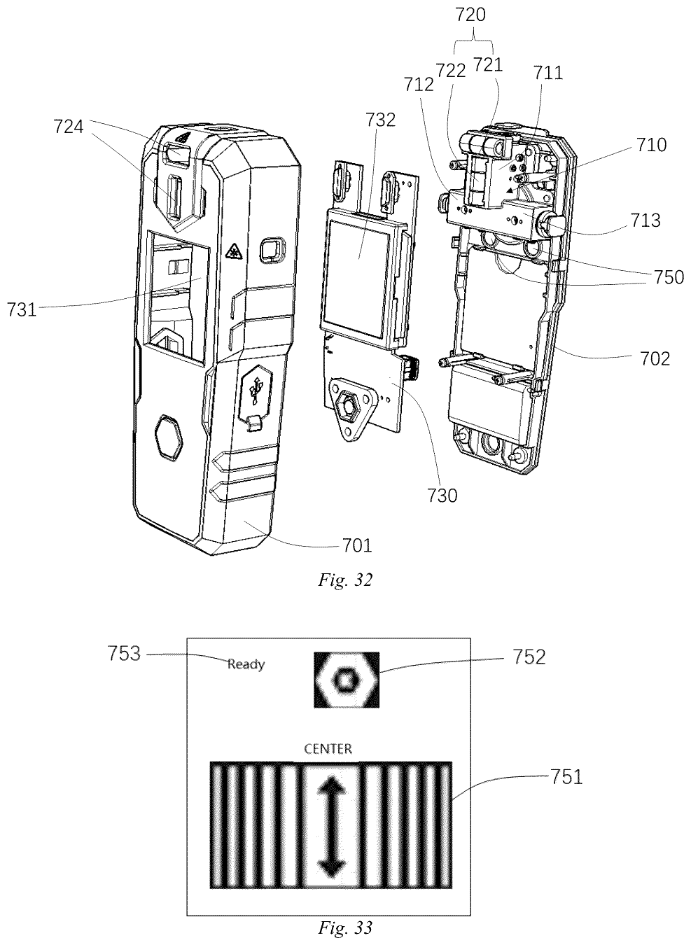

As shown in FIGS. 30 to 33, the multi-functional measuring apparatus 70 of this embodiment includes a housing 700 defining an internal cavity, in which the laser module 710, a level assembly 720 and the detection component are provided.

The housing 700 may be fabricated from a plastic or metal material, with a plastic material being preferred. In some implementations, the housing 700 includes a first shell 701 and a second shell 702. The first shell 701 is open at one side facing in a thickness direction, and the second shell 702 covers the opening so as to define the cavity together with the first shell 701.

The laser module 710 includes three laser assemblies, namely, a first laser assembly 711, a second laser assembly 712 and a third laser assembly 713. The first laser assembly 711 emits laser light in a first direction. The second laser assembly 712 emits laser light in a second direction. The third laser assembly 713 emits laser light in a third direction. The second direction is opposite to the third direction, and the first direction is perpendicular to both the second and third directions. For example, in case of the first direction being vertical, patterns that laser light emitted from the multi-functional measuring apparatus 70 of this embodiment can form includes, horizontal lines, vertical lines and crosses, which enable alignment in both the vertical and horizontal directions.

The level assembly 720 includes a first bubble 721 disposed at the top of the housing 700 (facing in the first direction), which may indicate a degree of levelness or verticality. Preferably, the first bubble 721 is horizontally arranged to indicate a degree of levelness.

In some implementations, the level assembly 720 further includes a second bubble 722, which may be vertically arranged under the first bubble 721. That is, the second bubble 722 and the first bubble 721 may be arranged perpendicularly to each other. The second bubble 722 may be used to indicate a degree of verticality.

The first bubble 721 and the second bubble 722 may be provided on a support 723, and the first shell 701 may define view windows 724 at the top, which are aligned with the respective bubbles, and through which the respective bubbles can be observed.

A PCB 730 is disposed in the cavity of the housing 700, and a display window 731 is provided at the middle of the first shell 701. A display device 732 is disposed in the display window 731, which can display information such as a state of the measuring apparatus 70 and measurements. The display device 732 is connected to the PCB 730. An opening is provided under the display window 731 in the first shell 701, and a first button 733 is disposed in the opening. The first button 733 is connected to the PCB 730. Another opening is provided in a side of the first shell 701, and a second button 734 is disposed in the opening. The second button 734 is connected to the PCB 730.

In some implementations, the multi-functional measuring apparatus 70 may be powered by an external power supply. In some implementations, the multi-functional measuring apparatus 70 may include a power supply module 740, which is disposed in the housing 700, as shown. The power supply module 740 may include a dry cell battery, a rechargeable battery, or the like, which serves as a power supply. Preferably, a rechargeable battery is included as a power supply. A USB charge port 741, which can be used to charge the rechargeable battery, is provided in a side of the first shell 701.

In some implementations, a first magnetic element 750 is provided on the first shell 701. The first magnetic element 750 may be inserted through the first shell 701 so as to be flush with a backside of the first shell 701. With this arrangement, the multi-functional measuring apparatus 70 can be attached to a vertical wall surface with the aid of an iron plate.

In some implementations of this embodiment, the multi-functional measuring apparatus 70 further includes a mounting plate, which enables the apparatus to be attached to a vertical surface being measured. The mounting plate is structured and attached to a vertical surface in the same manners as described above in the fourth and fifth embodiments.

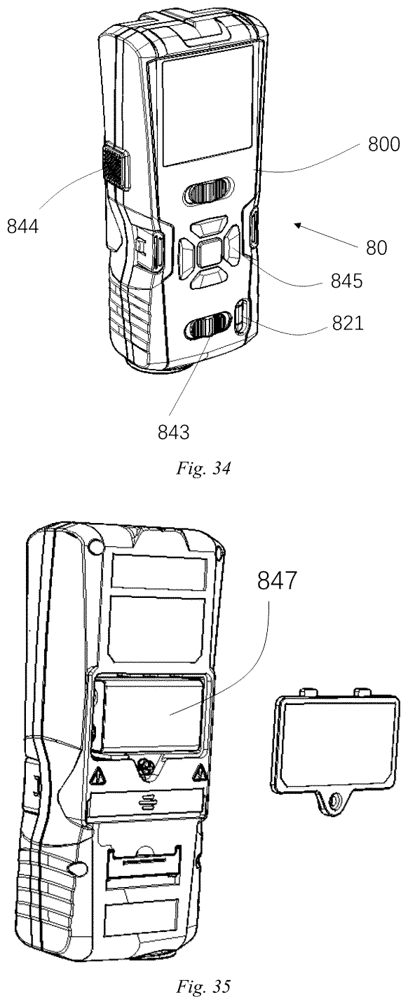

The detection component may be used to detect edges of a wood post, metal, wire or other object, from which the center of the object can be estimated. The detection component is the same as that of the sixth embodiment. As shown in FIG. 33, the display device 732 of this embodiment displays a first icon 751, a second icon 752 and a third icon 753. The first icon 751 consists of a series of bars which decrease in width from the middle to both sides one after another. The second icon 752 indicates whether an object being detected is made of a wood or metal material. The third icon 753 is a “READY” icon. In some implementations, two LED lamps and an acoustic alarm are further included, which are used to provide indications in a detection process performed by the measuring apparatus 70, or to indicate a result of detection.

A detection process performed by the detection component is as follows.

The measuring apparatus 70 is turned on by pressing the button on the left side, and is then placed on a wall being measured. A calibration process is initiated by a long press on the button on the left side. In response, the first icon 751 brightens up, and the bars roll inwardly to the center and then outwardly to the bottom. After that, the second icon 752 brightens up.

After the calibration process is completed, the third (“READY”) icon 753 brightens up and the first icon 751 dims down. In response, a battery life icon brightens up. Moreover, the two LEDs glow green, and the acoustic alarm beeps to given an indication.

The measuring apparatus 70 is then slowly moved on the wall. For example, when it is moved in a right-to-left direction over a wood or metal post, the left LED glows red and the right LED glows green. At the same time, the first icon 751 brightens up and the bars roll, but the middle one does not reach the middle position. The apparatus is then further moved to the left, and when it passes over the center of the wood or metal post, the middle bar in the first icon 751 reaches the middle position. In response, the two LEDs glow red, and the second icon 752 brightens up. At the same time, a line icon indicating the middle position brightens up, and the acoustic alarm beeps to give an indication.

The measuring apparatus 70 is then additionally moved to the left away from the center of the wood or metal post. In response, the second icon dims down. Moreover, the left LED instead glows green and the right LED still glows red until the first icon 751 dims down.

When the apparatus is moved over the wood or metal post in a left-to-right direction, the bars in the first icon roll in a reverse order.

In this embodiment, the detection component may be able to detect a wood or metal post located under it at a depth as large as 19 mm. Moreover, it may be able to detect a charged wire located under it at a depth as large as 35 mm. In this embodiment, three independent horizontal and vertical laser lines with high brightness can be projected, which can be used to achieve leveling and alignment. With the two built-in bubbles, it is ensured that leveling is achieved in a quick and accurate manner. This embodiment can be suitably used to locate wood and metal materials in walls, flooring and ceiling of houses, which are hidden from view.

### Example 8

In an eighth embodiment, there is provided a multi-functional measuring apparatus 80 with line projection, detection and rangefinding capabilities. It includes: a laser module 810 with line projection capabilities; a detection module for detecting edges of an object made of a wood, metal or other material, from which the center of the object can be estimated; and an ultrasonic component with rangefinding capabilities.

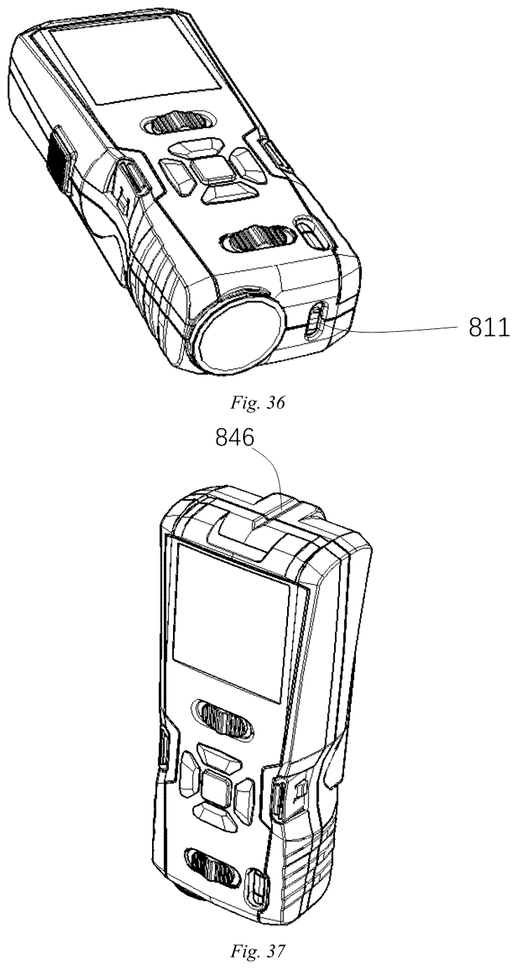

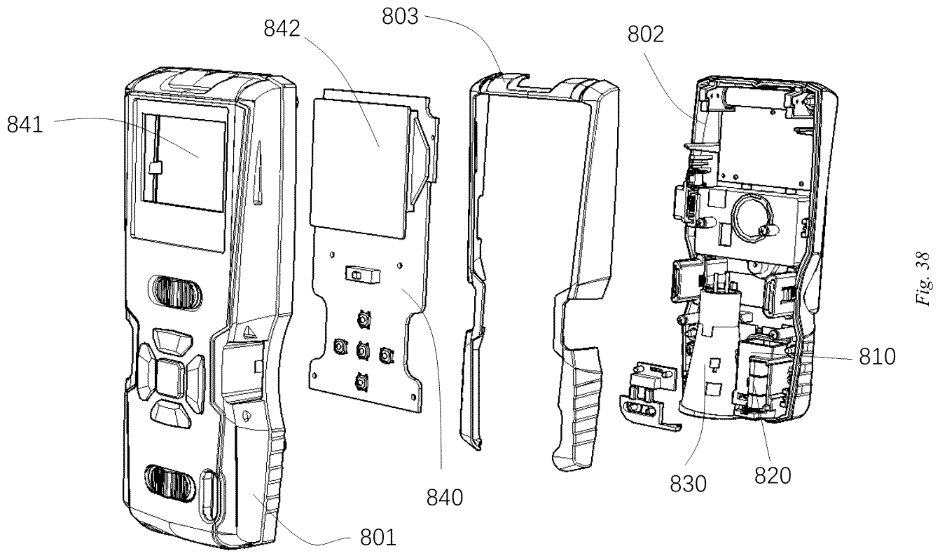

As shown in FIGS. 34 to 38, the multi-functional measuring apparatus 80 of this embodiment includes a housing 800 defining an internal cavity, in which the laser module 810, a level assembly 820, the detection component and the ultrasonic rangefinding component 830 are provided.

The housing 800 may be fabricated from a plastic or metal material, with a plastic material being preferred. In some implementations, the housing 800 includes a first shell 801 and a second shell 802. The first shell 801 is open at one side facing in a thickness direction, and the second shell 802 covers the opening so as to define the cavity together with the first shell 801. The first shell 801 may be further covered by a protective cover 803. The protective cover 803 may cover at least part of the exterior of the first shell 801.

The laser module 810 is provided in the housing 800, and one end of the housing 800 defines a light exit port 811. Laser light emitted from the laser module 810 can exit through the light exit port 811, achieving line projection.

The level assembly 820 includes a bubble disposed beside the laser module 810. The bubble may indicate a degree of levelness or verticality. Preferably, the bubble is vertically arranged to indicate a degree of verticality. The first shell 801 may define at its top a view window 821, which is aligned with the bubble, and through which the bubble can be observed.

The ultrasonic rangefinding component 830 is disposed on one side of the laser module 810. One end of the housing 800 facing in a lengthwise direction defines a notch, and a probe of the ultrasonic rangefinding component 830 is disposed at the notch.

A PCB 840 is disposed in the cavity of the housing 800, and a display window 841 is provided in the first shell 801. A display device 842 is disposed in the display window 841, which can display information such as a state of the measuring apparatus 80 and measurements. The display device 842 is connected to the PCB 840. An opening is also provided in the first shell 801, and a first button 843 is disposed in the opening. The first button 843 is connected to the PCB 840. The first button 843 may be switched between different positions, allowing selecting one of several operating modes. That is, one may be selected from a laser line projecting mode, a detecting mode and a rangefinding mode.

Another opening is provided in a side of the first shell 801, and a second button 844 is disposed in the opening. The second button 844 is connected to the PCB 840. The second button 844 is used in the same manner as described above in the sixth and seventh embodiments to trigger a detection function.

The other end of the first shell 801 opposing the light exit port 811 defines a measurement feature. As shown, the first shell 801 may define a V-shaped groove 846 extending in a widthwise direction.

In some implementations, a plurality of auxiliary buttons 845 may be provided on the housing 800, which are used to perform functions including data storage, retrieval of stored data, selection of modes, additive and subtractive operations, etc.

In some implementations, the multi-functional measuring apparatus 80 may be powered by an external power supply. In some implementations, the multi-functional measuring apparatus 80 may include a power supply module 847, which is disposed in the housing 800, as shown. The power supply module 847 may include a dry cell battery, a rechargeable battery, or the like, which serves as a power supply.

The detection component may be used to detect edges of a wood post, metal, wire or other object, from which the center of the object can be estimated. The detection component is the same as that of the sixth and seventh embodiments and, therefore, needs not be described in further detail herein. It should be understood that this detection function may be alternatively provided by an ultrasonic rangefinding component.

In this embodiment, the detection component may be able to detect a wood or metal post located under it at a depth as large as 24 mm. Moreover, it may be able to detect a charged wire located under it at a depth as large as 35 mm. In this embodiment, one independent horizontal or vertical laser line with high brightness can be projected, which can be used to achieve leveling and alignment. With the built-in bubble, it is ensured that leveling is achieved in a quick and accurate manner. The ultrasonic component can be used to measure a distance. The different buttons can be used to perform functions including data storage, retrieval of stored data, additive operations, etc. Based on such additive operations, the ultrasonic rangefinding component may further conduct area and volume calculations. This embodiment can be suitably used to locate wood and metal materials in walls, flooring and ceiling of houses, which are hidden from view.

Preferred specific embodiments of the present invention have been described in detail above. It is to be understood that those of ordinary skill in the art can make various modifications and changes based on the concept of the present invention without exerting any creative effort. Accordingly, all variant embodiments that can be obtained by those skilled in the art by logical analysis, inference or limited experimentation in accordance with the concept of the present invention on the basis of the prior art are intended to fall within the protection scope as defined by the claims.

1. A combination tool, characterized in comprising a housing defining an internal cavity, in which a laser module and a level assembly are provided, the laser module configured to produce spot-shaped laser light and/or linear laser light, the level assembly configured to indicate a degree of levelness.

2. The combination tool of claim 1, characterized in that the laser module comprises at least one laser assembly and is configured to be switchable between producing the spot- shaped laser light and producing the linear laser light.

3. The combination tool of claim 2, characterized in that the laser module comprises a laser assembly and a switching assembly, the switching assembly configured to be able to control the laser assembly to be switched between producing the spot-shaped laser light and producing the linear laser light.

4. The combination tool of claim 3, characterized in that the switching assembly comprises a slider slideable relative to the housing and a push button capable of driving the slider to slide, the push button connected to the slider, the slider provided with a through hole and a beam splitter, the slider configured so that laser light emitted from the laser assembly passes through the through hole when the slider is at a first position and that laser light emitted from the laser assembly passes through the beam splitter when the slider is at a second position.

5. The combination tool of claim 3, characterized in that the laser module comprises a first laser assembly and a second laser assembly, the first laser assembly configured to emit the spot-shaped laser light, the second laser assembly configured to emit the linear laser light.

6. The combination tool of claim 1, characterized in that the laser module comprises at least two laser assemblies configured to be able to produce laser lines which are perpendicular to each other.

7. The combination tool of claim 1, characterized in that the level assembly comprises at least one bubble configured to indicate a degree of verticality, a degree of perpendicularity or an angle.

8. The combination tool of claim 7, characterized in that the at least one bubble comprises a first bubble and a second bubble, wherein the first bubble is configured to indicate the degree of verticality or the degree of perpendicularity, and the second bubble is a rotatable bubble for indicating the angle, or wherein the first bubble and the second bubble are arranged perpendicularly to each other.

9. The combination tool of claim 7, characterized in that the level assembly further comprises a corner defined in a side wall of the housing, the corner having a first side and a second side, which are perpendicular to each other.

10. The combination tool of claim 7, characterized in that the level assembly further comprises an angle indicating component configured to indicate an angle at which the combination tool is located, the angle indicating component selected from a protractor or an electronic inclinometer.

11. The combination tool of claim 1, characterized in that the housing is made of a metal material.

12. The combination tool of claim 11, characterized in that the housing is integrally formed of the metal material and provided with a plurality of openings for mounting of the laser module and the level assembly.

13. The combination tool of claim 11, characterized in that a side of the housing defines a V-shaped groove extending in a lengthwise direction of the side.

14. The combination tool of claim 1, characterized in that the housing is made of a plastic material and comprises at least two shells which are put together to define the cavity.

15. The combination tool of claim 1, characterized in that the housing is provided therein with at least one magnetic element for attractively attaching the combination tool to an object to be measured.

16. The combination tool of claim 1, characterized in that the housing is provided therein with at least one rangefinding module comprising a tape measure and/or an ultrasonic rangefinding component.

17. The combination tool of claim 1, characterized in that the housing is provided therein with a detection module configured to detecting a center of a wood component and/or a center of a metal component.

18. The combination tool of claim 1, characterized in further comprising a mounting plate configured to be affixable to a vertical surface, wherein the housing is attached to the mounting plate by an attachment member.

19. The combination tool of claim 18, characterized in that the housing is provided with a micro switch configured to, when the housing is attached to the mounting plate, be triggered to cause the laser module to be turned on.

20. The combination tool of claim 18, characterized in that the mounting plate defines a tether hole and/or a lug, the lug defining a through hole for insertion of a fastener therethrough.
